(19) United States
(12) Patent Application Publication
(10) Pub. No.: US 2025/0133385 A1
(43) Pub. Date: Apr. 24, 2025

(54) PROVIDE DISCOVERY SECURITY MATERIALS FOR DISCOVERY

(71) Applicant: QUALCOMM Incorporated, San Diego, CA (US)

(72) Inventors: Hongil KIM, San Diego, CA (US); Soo Bum LEE, San Diego, CA (US); Hong CHENG, Basking Ridge, NJ (US); Sunghoon KIM, San Diego, CA (US)

(21) Appl. No.: 18/789,324

(22) Filed: Jul. 30, 2024

Related U.S. Application Data
(60) Provisional application No. 63/592,150, filed on Oct. 20, 2023.

(51) Int. Cl. H04W 8/00; H04W 12/04; H04W 84/04

(52) U.S. Cl. CPC H04W 8/005; H04W 12/04; H04W 84/042

(57) ABSTRACT

Apparatus, methods, and computer program products for sidelink discovery are provided. An example method may include transmitting, to a first network entity from a first public land mobile network (PLMN) associated with the UE, a discovery request. The example method may further include receiving, from the first network entity from the first PLMN, a discovery response including security information generated by a second network entity from a second PLMN associated with the UE. The example method may further include communicating a sidelink message based on the security information generated by the second PLMN.

### CROSS REFERENCE TO RELATED APPLICATIONS

This application claims the benefit of and priority to U.S. Provisional Patent Application No. 63/592,150, entitled “PROVIDE DISCOVERY SECURITY MATERIALS FOR DISCOVERY” and filed on Oct. 20, 2023, which is expressly incorporated by reference herein in its entirety.

### TECHNICAL FIELD

The present disclosure relates generally to communication systems, and more particularly, to wireless communication systems with discovery.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to transmit, to a first network entity from a first public land mobile network (PLMN) associated with the UE, a discovery request. Based at least in part on information stored in the at least one memory, the at least one processor, individually or in any combination, is configured to receive, from the first network entity from the first PLMN, a discovery response including security information generated by a second network entity from a second PLMN associated with the UE. Based at least in part on information stored in the at least one memory, the at least one processor, individually or in any combination, is configured to communicate a sidelink message based on the security information generated by the second PLMN.

In another aspect of the disclosure, a method, a computer-readable medium, and an apparatus at a first network entity associated with a first public land mobile network (PLMN) associated with a user equipment (UE) are provided. The apparatus may include at least one memory and at least one processor coupled to the at least one memory. Based at least in part on information stored in the at least one memory, the at least one processor, individually or in any combination, is configured to receive a discovery request associated with the UE. Based at least in part on information stored in the at least one memory, the at least one processor, individually or in any combination, is configured to transmit a request to a second network entity associated with a second PLMN associated with the UE to obtain security information from the second network entity. Based at least in part on information stored in the at least one memory, the at least one processor, individually or in any combination, is configured to receive, from the second network entity, a response responsive to the request, the response including the security information from the second network entity. Based at least in part on information stored in the at least one memory, the at least one processor, individually or in any combination, is configured to transmit, for the UE, a discovery response including the security information from the second PLMN.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4A and FIG. 4B are diagrams illustrating example communication flows for sidelink discovery, in accordance with various aspects of the present disclosure.

FIG. 5 is a diagram illustrating example direct discovery Model A, in accordance with various aspects of the present disclosure.

FIG. 6 is a diagram illustrating example direct discovery Model B, in accordance with various aspects of the present disclosure.

FIG. 7 is a diagram illustrating example UE to network relay, in accordance with various aspects of the present disclosure.

FIG. 8 is a diagram illustrating example UE to network relay discovery, in accordance with various aspects of the present disclosure.

FIG. 9 is a diagram illustrating example UE to network relay discovery, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a diagram illustrating an example of a hardware implementation for an example apparatus and/or network entity, in accordance with various aspects of the present disclosure.

FIG. 13 is a diagram illustrating an example of a hardware implementation for an example network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

A remote UE may be provisioned with different security information generated by different direct discovery name management functions (DDNMFs) or proximity services (ProSe) key management functions (PKMFs) associated with different public land mobile networks (PLMNs). Without knowing the PLMN that particular security information belongs to, the UE may use security information blindly, which may result in a UE using security information from a different PLMN than other UEs in the area are associated with. For example, a remote UE may be using security materials for a first visited PLMN (VPLMN) associated with the remote UE while trying to communicate with other UEs in a second VPLMN associated with the remote UE. Aspects provided herein enable a UE to store security information associated with a particular PLMN ID, which enables the UE to identify and use the security information in sidelink communications with other UEs. Aspects provided herein may reduce overall signaling overhead in the communication system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

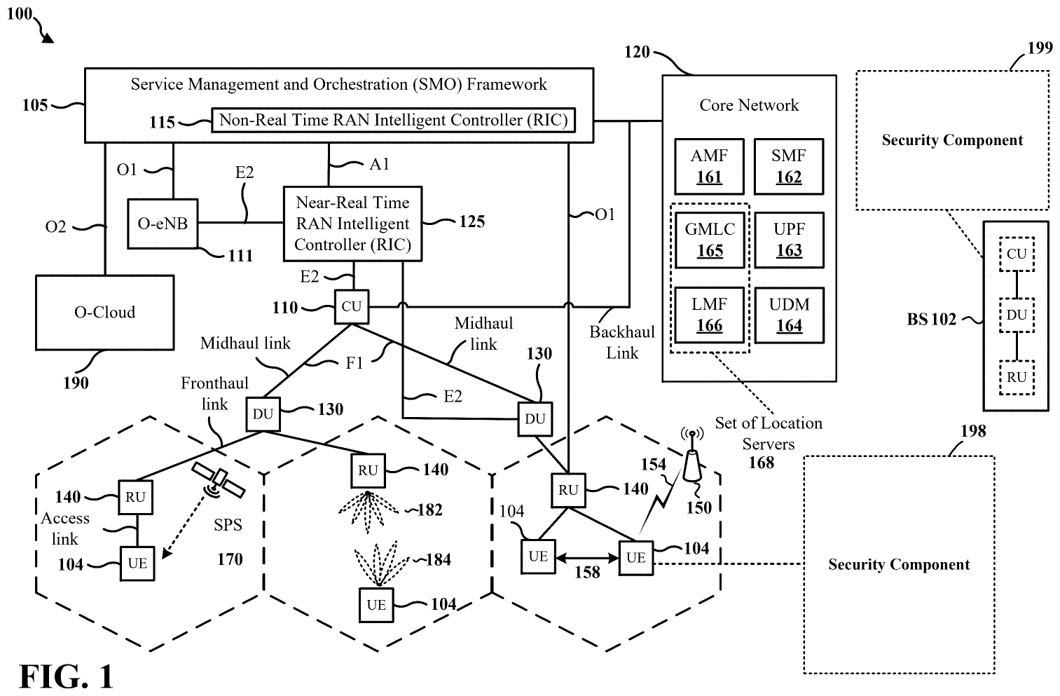

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a security component 198. In some aspects, the security component 198 may be configured to transmit, to a first network entity from a first public land mobile network (PLMN) associated with the UE, a discovery request. In some aspects, the security component 198 may be further configured to receive, from the first network entity from the first PLMN, a discovery response including security information generated by a second network entity from a second PLMN associated with the UE. In some aspects, the security component 198 may be further configured to communicate a sidelink message based on the security information generated by the second PLMN.

In certain aspects, the base station 102 may include a security component 199. In some aspects, the security component 199 may be configured to receive a discovery request associated with the UE. In some aspects, the security component 199 may be further configured to transmit a request to a second network entity associated with a second PLMN associated with the UE to obtain security information from the second network entity. In some aspects, the security component 199 may be further configured to receive, from the second network entity, a response responsive to the request, the response including the security information from the second network entity. In some aspects, the security component 199 may be further configured to transmit, for the UE, a discovery response including the security information from the second PLMN.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

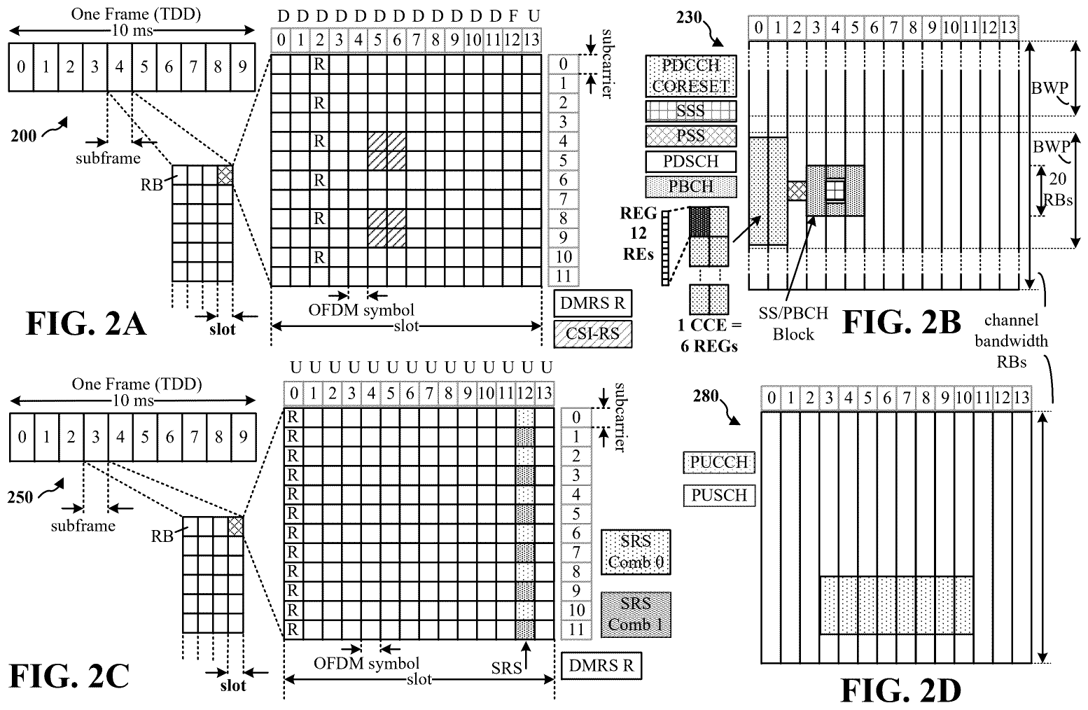

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

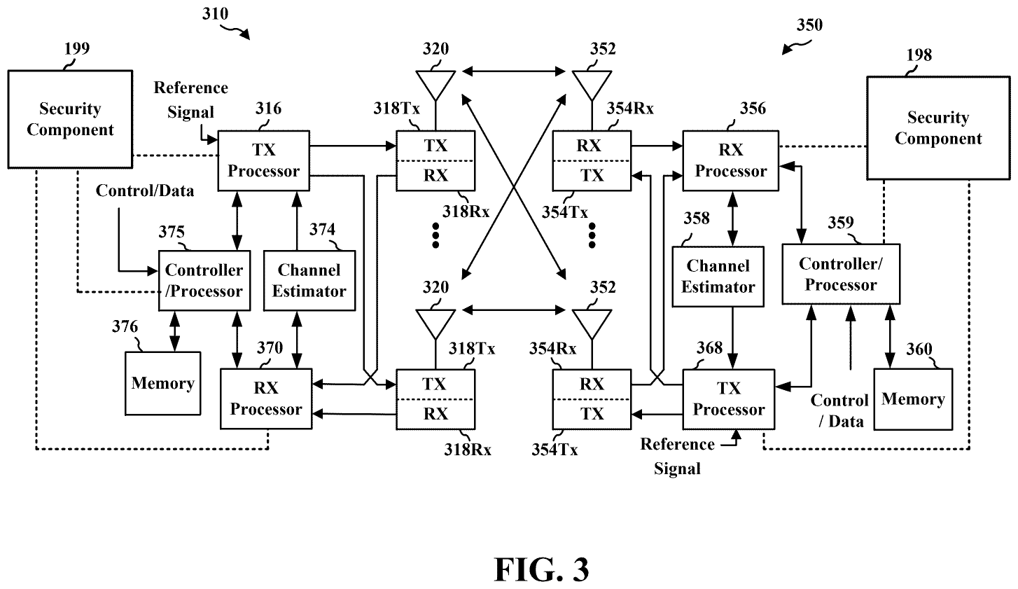

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with security component 198 of FIG. 1.

At least one of the TX processor 316, the RX processor 370, and the controller/processor 375 may be configured to perform aspects in connection with security component 199 of FIG. 1.

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc.

Sidelink communication may be based on different types or modes of resource allocation mechanisms. In a first resource allocation mode (which may be referred to herein as “Mode 1”), centralized resource allocation may be provided by a network entity. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots.

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the UE intends to use for sidelink transmission(s). For example, as part of a sensing mechanism for resource allocation Mode 2, the UE may determine (e.g., sense) whether a selected sidelink resource has been reserved by other UE(s) before selecting the sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field included in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources.

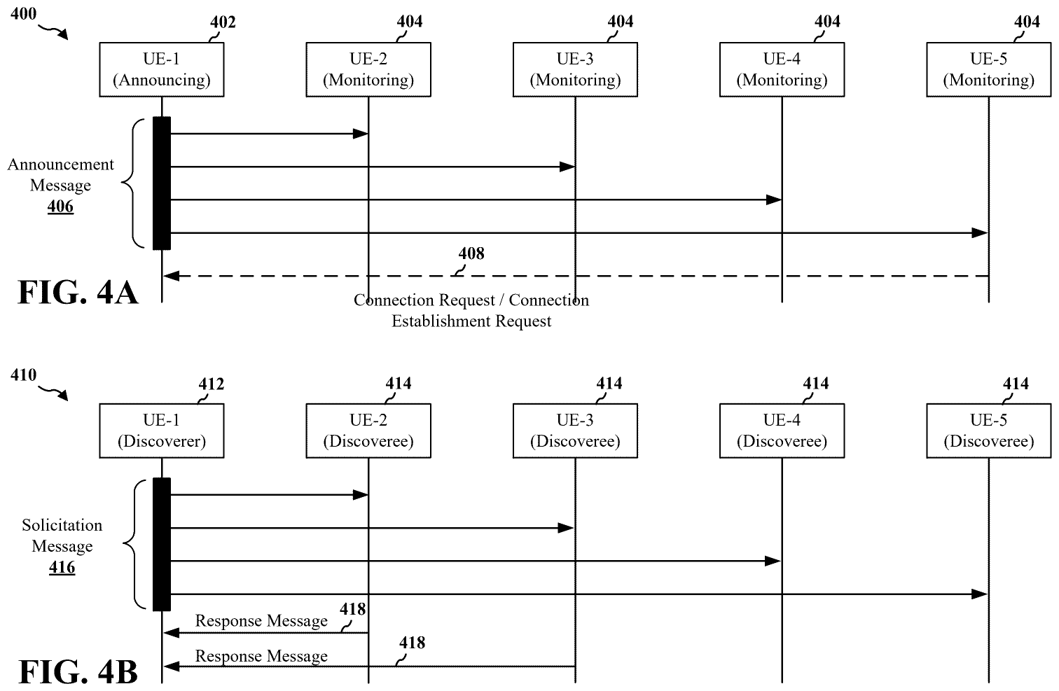

As discussed, sidelink devices may exchange direct sidelink communication with each other. To establish sidelink communication between sidelink devices (e.g., UEs), one sidelink device may attempt to discover another sidelink device via a discovery procedure at a higher layer (e.g., an application layer) of the protocol stack. The discovery mechanism may also be configured at a lower layer of the protocol stack. In one type of sidelink discovery model, as shown by a diagram 400 of FIG. 4A, to discover or determine the presence of another UE, a first UE 402 may broadcast/groupcast a discovery message. The discovery message may be an announcement message 406. The UE 402 may broadcast the announcement message 406 indicating its presence as a sidelink device to other UEs (e.g., UE(s) 404) within a transmission range of the UE 402. In response, the UE(s) 404 may transmit a connection request message 408 (which may also be referred to as a “connection establishment request message”) to the UE 402 if they are to establish a sidelink communication with the UE 402. For example, an UE may broadcast an announcement message that may be received by other UEs. A UE that receives the announcement message may respond with a message (e.g., a connection request) to the UE. After discovering each other, the UE 402 and the UE(s) 404 may exchange sidelink communication. The first sidelink device or the UE (e.g., the UE 402) transmitting the announcement message (e.g., announcement message 406) may be referred to as an announcing UE. The sidelink device(s) (e.g., UEs 404) transmitting the discovery response or monitoring for the announcement message may be referred to as the monitoring UE. The type of discovery involving a broadcast announcement and reply may be referred to as a first model of discovery, or “Model A” sidelink discovery.

In another type of sidelink discovery model, as shown by diagram 410 of FIG. 4B, a first UE 412 may broadcast a solicitation message 416 (which may also be referred to as a “discovery request message”) to one or more UE(s) 414. The UE 412 transmitting the solicitation message 416 may be referred to as a discoverer UE. In response, the UE(s) 414 receiving the solicitation message 416 may process the request and transmit a response message 418 to the UE 412. The UE(s) 414 transmitting the response message 418 may be referred to as a discoveree UE. The type of discovery including a solicitation message or a discovery request message may be referred to as a second type of discovery or “Model B” sidelink discovery.

Proximity services (ProSe) is a type of sidelink connection between devices over a direct wireless link (e.g., PC5 sidelink). ProSe, or other sidelink, direct discovery may be used for discovering another UE using the same application such as an application for public safety, social media, announce service, or the like. ProSe may also be used in connection with unicast mode ProSe direct communication for interactive applications across two devices. For example, ProSe or other sidelink communication may be used for extended reality communications between two devices, or public safety communications. ProSe communication, or other sidelink communication, may be based on a UE to network relay to extend coverage extension.

ProSe, as an example of sidelink communication, enables direct communication between UEs over a sidelink (e.g., PC5) interface. Sidelink communication, such as ProSe, provides discovery and communication capabilities. Direct discovery may be categorized into open discovery or restricted discovery. In open discovery, explicit permission from the UE being discovered may be not used. Integrity protection and replay protection may be applied. In restricted discovery, explicit permission from the UE being discovered may be used. Integrity protection, replay protection, scrambling protection and message specific confidentiality protection may be applied. A UE may be provided with the security parameters from the DDNMF. As used herein, the term “security information,” the term “security materials,” and the term “security parameters” may be used interchangeably and may refer to a relay use key (e.g., a ProSe relay user key (PRUK)), a discovery user integrity key, a discovery user scrambling key, a discovery user confidentiality key, or a ciphering algorithm generated by a network entity for protecting (e.g., encrypting) or receiving (e.g., decrypting) messages for sidelink discovery.

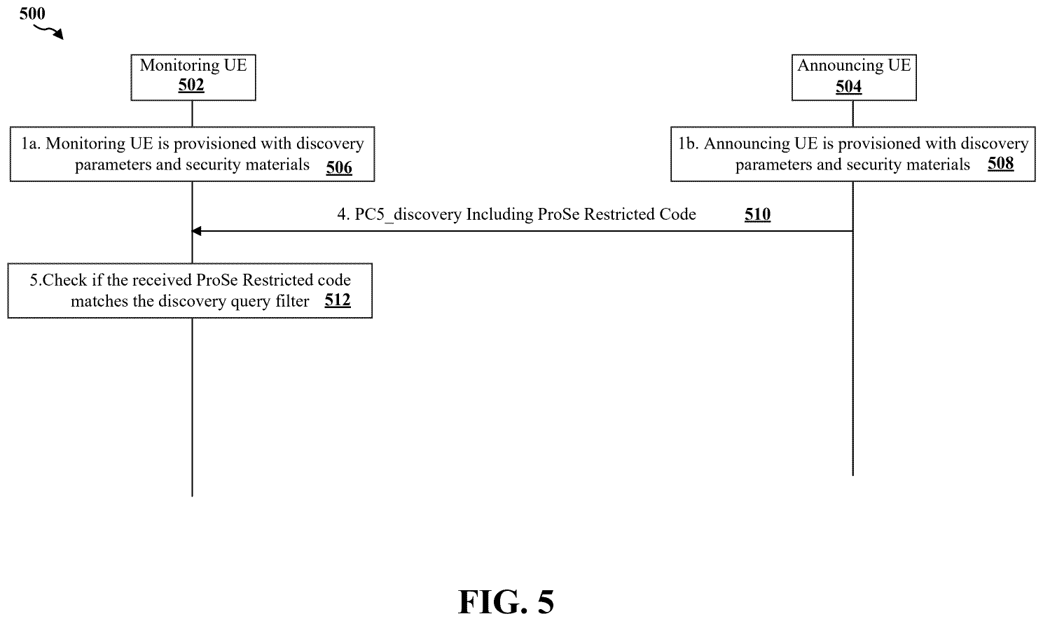

FIG. 5 is a diagram 500 illustrating example direct discovery Model A, in accordance with various aspects of the present disclosure. As illustrated in FIG. 5, a monitoring UE 502 and an announcing UE 504 may be provisioned with discovery parameters and security materials at 506 and 508. The discovery parameters and security materials may include a ProSe query code, a ProSe response code, a ProSe restricted code, or the like. The discovery parameters may include parameters or information that enable the UE to perform discovery (e.g., ProSe Direct discovery), such as the mapping of ProSe services to Destination Layer 2 ID, application identifiers, or a validity timer. Security materials may include parameters or information used to protect the discovery message, such as a code-sending security parameter or a code-receiving security parameter such as a discovery user integrity key, a discovery user scrambling key, a discovery user confidentiality key, a ciphering algorithm (e.g., indication of the ciphering algorithm or parameters used), or the like. The announcing UE 504 may transmit a discovery message 510 that may include a service code (e.g., ProSe restricted code), announcer information associated with the announcing UE 504, ProSe relay UE ID, announcer information, a message integrity check (MIC), or a time-based counter, such as a coordinated universal time (UTC)-based counter. A MIC is used to check the integrity of the discovery message, and may further enable a UE or a network to verify that an announcing UE is indeed authorized to announce an application code at that time instance. The UTC-based counter may be used to calculate the MIC and verify the MIC. The discovery message 510, for example, may be protected with a code-sending security parameter, via scrambling, ciphering and/or integrity protection. Upon receiving the discovery message 510, at 512, the UE 502 may check if the received code (e.g., ProSe restricted code) matches the discovery filter. If the restricted code matches the discovery filter, the UE 502 may check the MIC or perform a match report procedure.

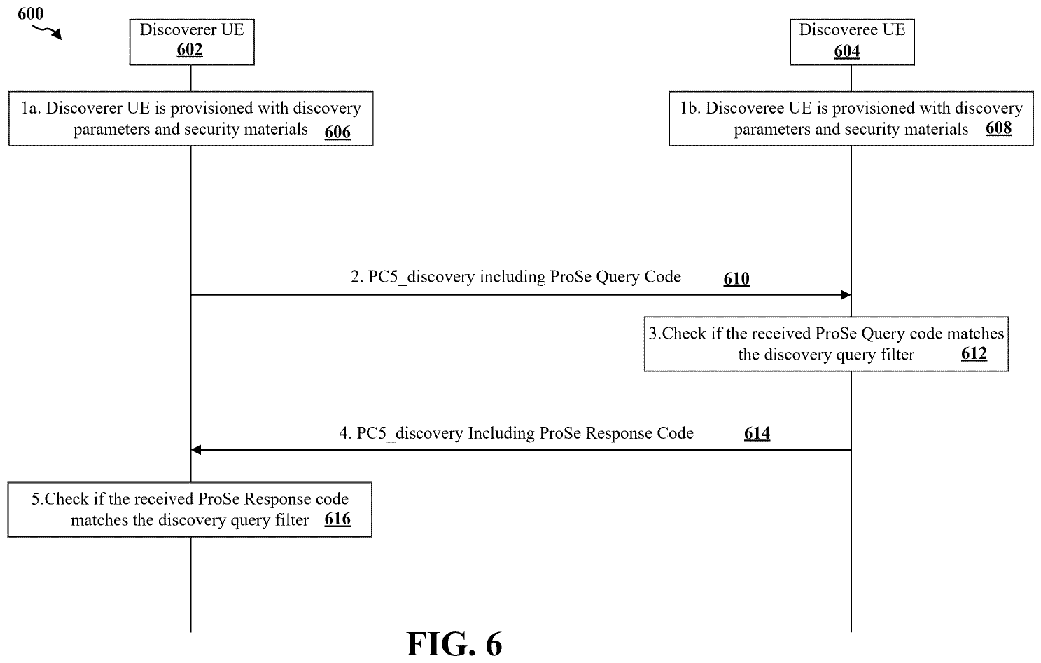

FIG. 6 is a diagram 600 illustrating example direct discovery Model B, in accordance with various aspects of the present disclosure. The discoverer UE 602 and the discoveree UE 604 may be provisioned with discovery parameters and security materials, at 606 and 608. The discovery parameters and security materials may include a ProSe query code, a ProSe response code, a ProSe restricted code, or the like. The discovery parameters may include parameters or information that enable the UE to perform discovery (e.g., ProSe Direct discovery), such as the mapping of ProSe services to Destination Layer 2 ID, application identifiers, or a validity timer. Security materials may include parameters or information used to protect the discovery message, such as a code-sending security parameter or a code-receiving security parameter such as a discovery user integrity key, a discovery user scrambling key, a discovery user confidentiality key, a ciphering algorithm (e.g., indication of the ciphering algorithm or parameters used), or the like. In some aspects, UE 602 may transmit a service code, such as a query code (e.g., ProSe query code), that is protected based on a code-sending security parameter. UE 604, on receiving the query code from UE 602, removes the protection using the code-receiving security parameters and further checks whether the received query code matches the code that UE 604 supports using a discovery query filter. If the match is successful, UE 604 may transmit a response code (e.g., ProSe response code) that is protected based on a code-sending security parameter. UE 602 removes the protection of the received response code and further checks whether the received response code matches the code UE 602 is expecting, using the discovery filter. The UE 602 may transmit a discovery message 610 based on the provisioned discovery parameters and security materials provisioned at 606. The discovery message 610 may be a PC5 discovery message that includes the query code (e.g., ProSe query code), discoverer information, an MIC, a time-based counter (e.g., UTC-based counter), or the like. The PC5 discovery message may be protected with a code-sending security parameter, via scrambling and/or integrity protection. Upon receiving the discovery message 610, at 612, the UE 604 may verify the query code in the discovery message 610. For example, UE 604 may unscramble the discovery message using the code-receiving security parameter provisioned at 608. At 612, UE 604 may check whether the query code in the discovery message matches a discovery query filter. In some aspects, the UE 604 may transmit a discovery message 614 (e.g., PC5 discovery message) that includes a response code (e.g., ProSe response code), discoveree information, an MIC, a time-based counter (e.g., UTC-based counter), or the like. The PC5 discovery message may be protected with a code-sending security parameter provisioned at 608. Upon receiving the discovery message 614, at 616, UE 602 may unscramble the PC5 discovery message using the code-receiving security parameter. The UE 602 may check whether the response code is expected or matches a discovery response filter.

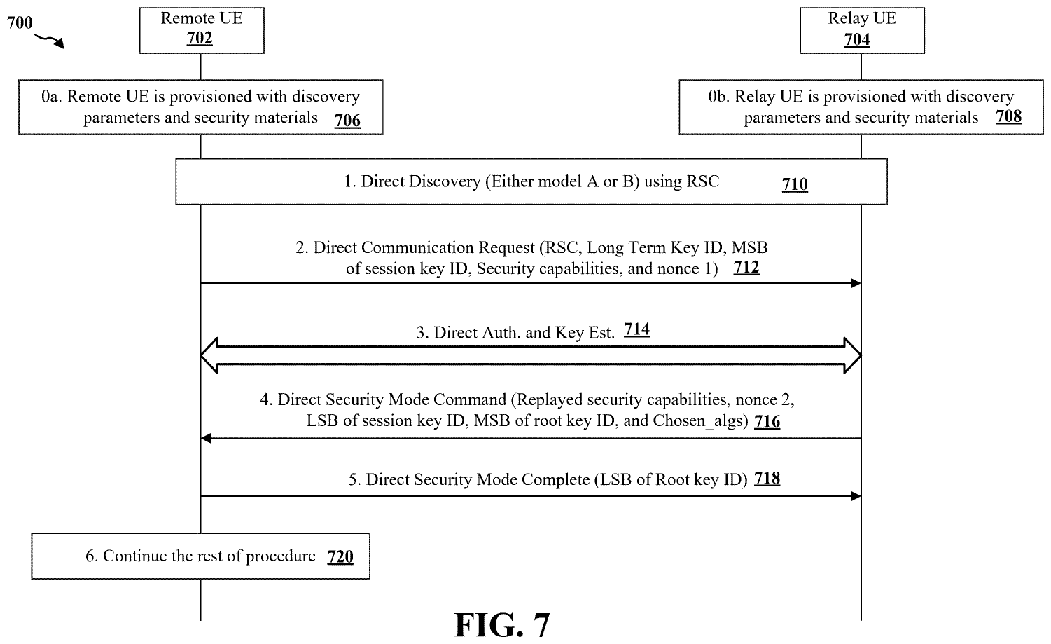

FIG. 7 is a diagram 700 illustrating example UE to network relay, in accordance with various aspects of the present disclosure. UE to network relay may be used to provide network connection to cell-edge and out-of-coverage remote UEs. At 706 and 708, UE 702 and UE 704 may be provisioned with discovery parameters and security materials. The discovery parameters and security materials may include a relay service code (RSC). The discovery parameters may include parameters or information that enable the UE to perform discovery (e.g., ProSe Direct discovery), such as the mapping of ProSe services to Destination Layer 2 ID, application identifiers, or a validity timer. Security materials may include parameters or information used to protect the discovery message, such as a code-sending security parameter or a code-receiving security parameter such as a discovery user integrity key, a discovery user scrambling key, a discovery user confidentiality key, a ciphering algorithm (e.g., indication of the ciphering algorithm or parameters used), or the like. At 710, UE 702 and UE 704 may perform direct discovery using, for example, based on model A or model B. The UE 702 may transmit a connection message 712 that includes a long term key ID, a most significant bit (MSB) of a session key ID, security capabilities, a first nonce, or the like, to the UE 704. A long term key may be provisioned into the UE and may be the root of the security for one-to-one communications. The long term key may be a symmetric key or a public/private key pair depending on the particular use case. Security capabilities may indicate which security algorithms supported by the UE. A long term key and its ID may become a PRUK and PRUK ID in the case of UE-to-network relay. In some aspects, the UE 702 and the UE 704 may perform a direct authentication and key establishment procedure at 714, The UE 704 may transmit a direct security mode command 716 to the UE 702 to establish a session key. The direct security mode command 716 may include replayed security capabilities, a second nonce, a least significant bit (LSB) of a session key ID, an MSB of a root key ID, an indication of algorithms (e.g., Chosen_algs), or the like. UE 702 may transmit a reply, such as a direct security mode complete message 718. The direct security mode complete message 718 may include an LSB of a root key ID. The UE 702 and the UE 704 may continue with establishing a direct connection link and communicating on the direct connection link at 720.

A remote UE may be provisioned with different security information generated by different direct discovery name management functions (DDNMFs) or proximity services (ProSe) key management functions (PKMFs) associated with different public land mobile networks (PLMNs). Without knowing the PLMN that particular security information belongs to, the UE may use security information blindly and may result in a UE using security information from a different PLMN that other UEs in the area may not be associated with. For example, a remote UE may be using security materials for a first visited PLMN (VPLMN) associated with the remote UE while trying to communicate with other UEs in a second VPLMN associated with the remote UE. Aspects provided herein enable a UE to be able to store security information as associated with a particular PLMN ID, therefore using the correct security information in sidelink communications with other UEs. Aspects provided herein may lead to less overall signaling overhead in the communication system.

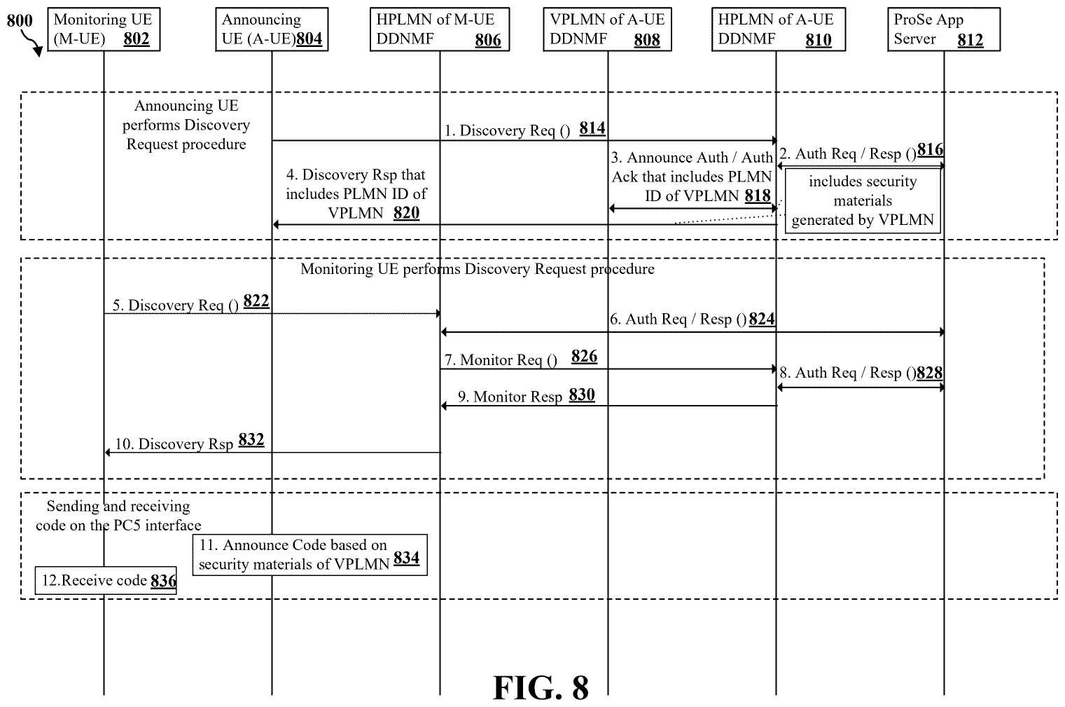

FIG. 8 is a diagram 800 illustrating example UE to network relay discovery, in accordance with various aspects of the present disclosure. Steps 1-4 relates to an announcing UE 804 performing discovery request procedure. As illustrated in FIG. 8, the announcing UE 804 may send a discovery request message 814 containing a restricted ProSe application user ID (RPAUID) to the DDNMF 810 in the announcing UE 804's home PLMN (HPLMN) in order to get the ProSe code to announce and to get the associated security material. In addition, the announcing UE 804 may include its PC5 UE security capability that contains the list of supported ciphering algorithms by the UE 804, in the discovery request message 814.

The DDNMF 810 may check for the announce authorization with the ProSe application server 812 by exchanging authorization request/response at 816. If the announcing UE 804 is roaming, the DDNMF 810 in the HPLMN and the DDNMF 808 of the visited PLMN (VPLMN) of the announcing UE 804 may exchange announce authorization 818 (Auth) (e.g., the DDNMF 810 may transmit an announce authorization and receive an announce authorization acknowledgment) so that the DDNMF 810 may obtain a PLMN ID associated with the VPLMN and ProSe code and the corresponding code-sending security parameters, along with the CURRENT_TIME and MAX_OFFSET parameters for the VPLMN. The parameters CURRENT_TIME and MAX_OFFSET may be parameters for ensuring that the obtained UTC-based counter is sufficiently close to real time to protect against replays.

The DDNMF 810 in the HPLMN of the announcing UE 804 may return the PLMN ID associated with the ProSe code and the corresponding code-sending security parameters, along with the CURRENT_TIME and MAX_OFFSET parameters to the UE 804 in a discovery response message 820. The code-sending security parameters may provide the security information for the announcing UE 804 to protect the transmission of the ProSe code (e.g., discovery user integrity key, discovery user scrambling key, and discovery use confidentiality key) and may be stored with the ProSe code by the UE 804, along with the associated PLMN ID of the VPLMN. The DDNMF 810 in the HPLMN of the announcing UE 804 may also include the chosen PC5 ciphering algorithm in the discovery response message 820, along with the PLMN ID. In addition, the DDNMF 810 in the HPLMN of the announcing UE 804 may include the PC5 security policies in the discovery response message 820, along with the PLMN ID. The DDNMF 810 may get the PC5 security policies in different ways (e.g., from PCF, from ProSe application server 812, or based on local configuration). The DDNMF 810 may get the chosen PC5 ciphering algorithm and the code-sending security parameters from the DDNMF 808.

Steps 5-10 may relate to operations of a monitoring UE 802. The monitoring UE 802 may send a discovery request message 822 containing the RPAUID and PC5 UE security capability to the DDNMF 806 in the monitoring UE 802's HPLMN (which may be the VPLMN of the announcing UE 804 in some aspects) in order to be allowed to monitor for one or more RPAUIDs. The DDNMF 806 in the HPLMN of the monitoring UE 802 may send an authorization request as part of 824 to the ProSe application server 812. If, based on the permission settings, the RPAUID is allowed to discover at least one of the target RPAUIDs contained in the application level container, the ProSe application server 812 may return an authorization response as part of 824. If the discovery request is authorized, and the PLMN ID in the Target RPAUID indicates a different PLMN, the DDNMF 806 in the HPLMN of the monitoring UE 802 may contact the indicated PLMN's DDNMF, i.e., the DDNMF 810 in the HPLMN of the announcing UE 804, by sending a monitor request message 826. The DDNMF 806 in the HPLMN of the monitoring UE 802 may exchange authorization messages 824 with the ProSe application server 812. The DDNMF 810 in the HPLMN of the announcing UE 804 may respond to the DDNMF 806 in the HPLMN of the monitoring UE 802 with a monitor response message 830 including the ProSe code, the corresponding code-receiving security parameters, a discovery user integrity key, and a chosen PC5 ciphering algorithm. The code-receiving security parameters may provide the security information that may be used by the monitoring UE 802 to undo the protection applied by the announcing UE 804 (e.g., discovery user integrity key, discovery user scrambling key, and discovery use confidentiality key). The discovery user integrity key may be included as a separate parameter if the code-receiving security parameters indicate that the monitoring UE 802 use Match Reports for MIC checking. The DDNMF 806 in the HPLMN of the monitoring UE 802 stores the ProSe code and the Discovery User Integrity Key (if it received one outside of the code-receiving security parameters). In some aspects, the DDNMF 810 in the HPLMN of the announcing UE 804 may exchange authorization messages 828 with the ProSe application server 812. The DDNMF 810 in the HPLMN of the announcing UE 804 may send the PC5 security policies to the DDNMF 806 in the HPLMN of the monitoring UE 802. There may be two configurations possible for integrity checking, 1) MIC checked by the DDNMF, and 2) MIC checked at the UE side. Which of the configuration is used may be decided by the DDNMF that assigned the ProSe code being monitored, and signaled to the monitoring UE 802 in the code-receiving security parameters.

The DDNMF 806 in the HPLMN of the monitoring UE 802 may return the discovery filter and the code-receiving security parameters, along with the CURRENT_TIME and MAX_OFFSET parameters and the chosen PC5 ciphering algorithm, along with the associated PLMN ID (e.g., the PLMN ID of the HPLMN of the announcing UE 804), in the discovery response 832. In some aspects, the discovery filter and the code-receiving security parameters, along with the CURRENT_TIME and MAX_OFFSET parameters and the chosen PC5 ciphering algorithm, may be provided (e.g., generated) by the DDNMF 810 in the HPLMN of the announcing UE 804. In some aspects, the monitoring UE 802 may save the discovery filter and the code-receiving security parameters, along with the CURRENT_TIME and MAX_OFFSET parameters and the chosen PC5 ciphering algorithm, as associated with the PLMN ID. The monitoring UE 802 takes the same actions with CURRENT_TIME and MAX_OFFSET as described for the monitoring UE 802. The UE 802 may store the discovery filter, code-receiving security parameters, and the chosen PC5 ciphering algorithm. If the DDNMF 806 in the HPLMN of the monitoring UE 802 receives the PC5 security policies, the monitoring UE 802's DDNMF 806 may forward the PC5 security policies to the monitoring UE 802 in the discovery response 832.

Steps 11 and 12 occur over PC5. In some aspects, the UE 804 may start announcing at 834, if the UTC-based counter provided by the system associated with the discovery slot is within the MAX_OFFSET of the announcing UE 804's ProSe clock and if the validity timer has not expired. The UE forms the discovery message and protects it with the security materials that is stored to be associated with the PLMN ID of the VPLMN associated with the UE 802. The four least significant bits of UTC-based counter may be transmitted along with the protected discovery message. The monitoring UE 802 may listen for, at 836 a discovery message that satisfies its discovery filter if the UTC-based counter associated with that discovery slot is within the MAX_OFFSET of the monitoring UE's ProSe clock. In order to find such a matching message, it processes the message. If the Monitoring UE was not asked to send Match Reports for MIC checking, it stops at this step from a security perspective. Otherwise, it may proceed to a match report procedure.

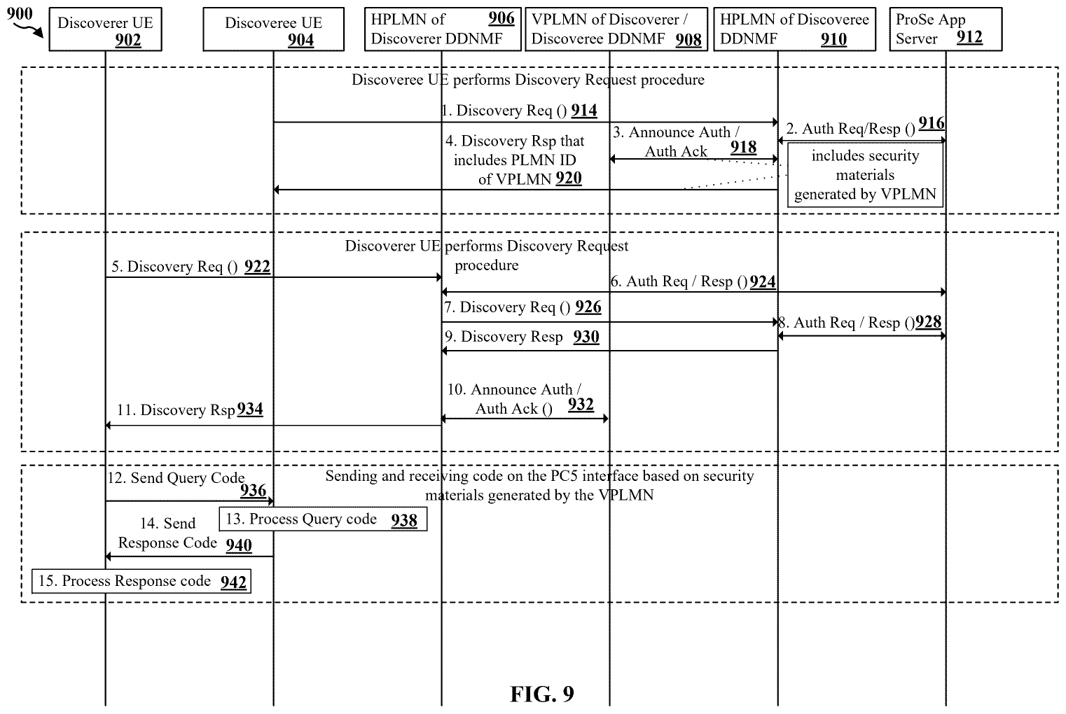

FIG. 9 is a diagram 900 illustrating example UE to network relay discovery, in accordance with various aspects of the present disclosure.

Steps 1-4 relates to operations of a discoveree UE 904. The discoveree UE 904 may send a discovery request message 914 containing the RPAUID to the DDNMF 906 in its HPLMN in order to get discovery query filter(s) to monitor a query, the ProSe response code to announce and associated security materials. The command may indicate that this is for ProSe Response (Model B) operation, i.e., for a discoveree UE 904. In addition, the discoveree UE 904 may include its PC5 UE security capability that contains the list of supported ciphering algorithms by the UE, in the discovery request message.

Upon receiving the discovery request message 914, the DDNMF 906 may check for the announce authorization (e.g., by exchanging authorization request and response message at 916) with the ProSe application server 912 depending on DDNMF configuration. The DDNMF 906 in the HPLMN and the DDNMF 908 of the VPLMN of the discoveree UE 904 may exchange announce auth messages at 918, which may include a PLMN ID of the VPLMN and ProSe response code and the code-sending security parameters, discovery query filter(s), code-receiving security parameters corresponding to each discovery filter along with the CURRENT_TIME and MAX_OFFSET parameters and the chosen PC5 ciphering algorithm. In some aspects, if the discoveree UE 904 is not roaming, the announce auth messages may not be exchanged.

The DDNMF 906 in the HPLMN of the discoveree UE 904 may return the PLMN ID of the VPLMN and the ProSe response code and the code-sending security parameters, discovery query filter(s), or the code-receiving security parameters corresponding to each discovery filter along with the CURRENT_TIME and MAX_OFFSET parameters or the chosen PC5 ciphering algorithm to the UE 904 in a discovery response message 920. The UE 904 may save the PLMN ID as associated with the other information, such as the ProSe response code and the code-sending security parameters, discovery query filter(s), or the code-receiving security parameters corresponding to each discovery filter along with the CURRENT_TIME and MAX_OFFSET parameters or the chosen PC5 ciphering algorithm. The code-sending security parameters may provide the information for the discoveree UE 904 to protect the transmission of the ProSe response code and are stored with the ProSe Response Code. The code-receiving security parameters provide the information utilized by the discoveree UE 904 to undo the protection applied to the ProSe query code by the discoverer UE 902. The code-receiving security parameters may indicate a match report will not be used for MIC checking. The UE 904 may store each discovery filter with its associated code-receiving security parameters and the associated PLMN ID. The discoveree UE 904 may take actions with CURRENT_TIME and MAX_OFFSET. The DDNMF 906 in the HPLMN of the discoveree UE 904 may include the chosen PC5 ciphering algorithm in the discovery response message 920 and the UE 904 may store the chosen PC5 ciphering algorithm with the associated PLMN ID.

In addition, the DDNMF 910 in the HPLMN of the discoveree UE 904 may include the PC5 security policies in the discovery response message. DDNMF may get the PC5 security policies in different ways (e.g., from PCF, from ProSe application server 912, or based on local configuration).

Steps 5-10 may relate to operations of a discoverer UE 902. In some aspects, the discoverer UE 902 may send a discovery request message 922 containing the RPAUID and the PC5 UE security capability to the DDNMF 906 in its HPLMN in order to be allowed to discover one or more restricted ProSe application user IDs.

The DDNMF 906 in the HPLMN of the discoverer UE 902 may send an authorization request at 924 to the ProSe application server 912. If the RPAUID is allowed to discover at least one of the Target RPAUIDs contained in the Application Level Container, the ProSe application server 912 returns an authorization response at 924.

If the discovery request is authorized, and the PLMN ID in the Target RPAUID indicates a different PLMN, the DDNMF 906 in the HPLMN of the discoverer UE 902 may contact the indicated PLMN's DDNMF, i.e., the DDNMF 910 in the HPLMN of the discoveree UE 904, by sending a discovery request message 926. The DDNMF 910 in the HPLMN of the discoveree UE 904 may exchange authorization messages with the ProSe application server 912 at 928. The DDNMF 910 in the HPLMN of the discoveree UE 904 may respond to the DDNMF 906 in the HPLMN of the discoverer UE 902 with a discovery response message 930 that may include the ProSe Query Code(s) and their associated code-sending security parameters, ProSe Response Code and its associated code-receiving security parameters, a discovery user integrity key for the ProSe response code, and a chosen PC5 ciphering algorithm. The code-receiving security parameters may provide the information used by the discoverer UE 902 to undo the protection applied by the discoveree UE 904. The discovery user integrity key may be included as a separate parameter if the code-receiving security parameters indicate that the discoverer UE 902 use match reports for MIC checking. The DDNMF in the HPLMN of the discoverer UE 902 may store the ProSe response code and the discovery user integrity key (if it received one outside of the code-receiving security parameters). The code-sending security parameters may provide the information utilized by the discoverer UE 902 to protect the ProSe Query Code.

The DDNMF in the HPLMN of the discoveree UE 904 may send the PC5 security policies to the DDNMF in the HPLMN of the discoverer UE 902.

There may be two configurations possible for integrity checking, 1) MIC checked by the DDNMF, and 2) MIC checked at the UE side. The configuration may be decided by the DDNMF that assigned the ProSe code being monitored, and signalled to the monitoring UE 802 in the code-receiving security parameters.

The DDNMF 906 in the HPLMN and the DDNMF 908 in the VPLMN of the discoverer UE 902 may exchange announce auth messages at 932. If the discoverer UE 902 is not roaming, the announce auth messages may not be exchanged.

The DDNMF in the HPLMN of the discoverer UE 902 may return the discovery response filter and the code-receiving security parameters, the ProSe Query Code, the code-sending security parameters along with the CURRENT_TIME and MAX_OFFSET parameters and the chosen PC5 ciphering algorithm, along with the associated PLMN ID (e.g., the PLMN ID of the HPLMN of the discoveree UE 904), to the discoverer UE 902 in a discovery response 934. In some aspects, the discoverer UE 902 may save the discovery filter and the code-receiving security parameters, along with the CURRENT_TIME and MAX_OFFSET parameters and the chosen PC5 ciphering algorithm, as associated with the PLMN ID. In some aspects, the discovery filter and the code-receiving security parameters, along with the CURRENT_TIME and MAX_OFFSET parameters and the chosen PC5 ciphering algorithm, may be provided (e.g., generated) by the DDNMF 910 in the HPLMN of the discoveree UE 904. The discoverer UE 902 may be also be configured with CURRENT_TIME and MAX_OFFSET. The UE may store the discovery response Filter and its code-receiving security parameters and the ProSe Query Code and its code-sending security parameters, and the chosen PC5 ciphering algorithm.

If the DDNMF 906 in the HPLMN of the discoverer UE 902 receives the PC5 security policies, the discoverer UE 902's DDNMF may forward the PC5 security policies to the discoverer UE 902.

The discoverer UE 902 may send the ProSe query code at 936 and also listens for a response message 940 if the UTC-based counter provided by the system associated with the discovery slot is within the MAX_OFFSET of the Discoverer UE's ProSe clock and if the Validity Timer has not expired. The discoverer UE 902 may form the discovery message and protect it based on the received code-sending security parameters and the chosen PC5 ciphering algorithm. The four least significant bits of UTC-based counter may be transmitted along with the protected discovery message. The discoveree UE 904 may listen for a discovery message that satisfies its discovery filter if the UTC-based counter associated with that discovery slot is within the MAX_OFFSET of the discoveree UE 904's ProSe clock. In order to find such a matching message, it may process the message transmitted at 936 based on the code-sending security parameters, and the chosen PC5 ciphering algorithm associated with the PLMN ID of the VPLMN of the discoveree UE 904. The discoveree UE 904 may send the ProSe response code in the response message 940 associated with the discovered ProSe query code, which may be associated with and stored as associated with the PLMN ID of the VPLMN of the discoveree UE 904. The discoveree UE 904 may form the discovery message and protects it based on the code-sending security parameters, and the chosen PC5 ciphering algorithm associated with the PLMN ID of the VPLMN of the discoveree UE 904. The four least significant bits of UTC-based counter may be transmitted along with the protected discovery message. The discoverer UE 902 listens for a discovery message that satisfies its discovery filter. In order to find such a matching message, it processes the message at 942. If the discoverer UE 902 was not asked to send match reports for MIC checking, it stops at this step from a security perspective. Otherwise, it may proceed with a match report procedure.

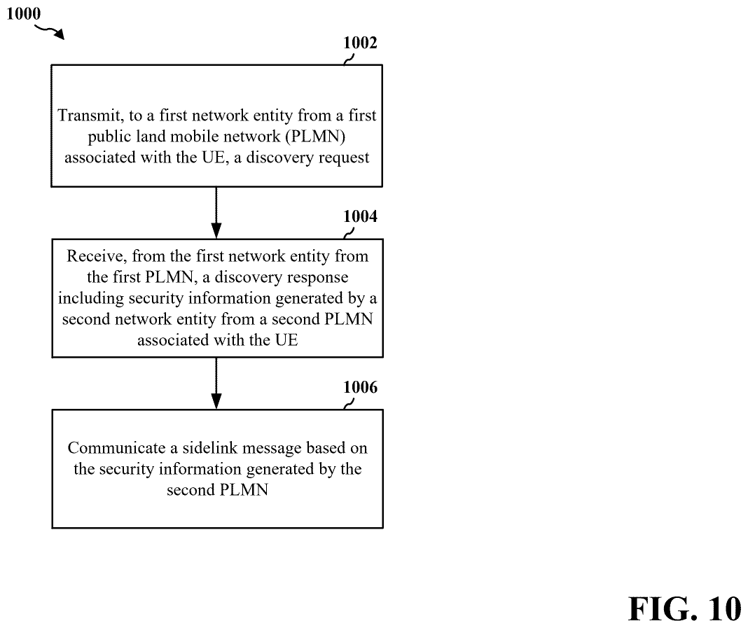

FIG. 10 is a flowchart 1000 of a method of wireless communication. The method may be performed by a UE (e.g., the UE 104, 350, 802, 804, 902, 904; the apparatus 1204). The method provides improved security aspects for UE to network relay that enables a remote UE and a relay UE to identify and use security information for wireless communication.

At 1002, the UE may transmit, to a first network entity from a first public land mobile network (PLMN) associated with the UE, a discovery request. For example, the UE 804 or the UE 904 may transmit, to a first network entity (e.g., 810 or 910) from a first public land mobile network (PLMN) associated with the UE, a discovery request (e.g., 814 or 914). In some aspects, 1002 may be performed by security component 198.

At 1004, the UE may receive, from the first network entity from the first PLMN, a discovery response including security information generated by a second network entity from a second PLMN associated with the UE. For example, the UE 804 or the UE 904 may receive, from the first network entity (e.g., 810 or 910) from the first PLMN, a discovery response (e.g., 820 or 920) including security information generated by a second network entity from a second PLMN associated with the UE. In some aspects, 1004 may be performed by security component 198. In some aspects, the discovery response further includes one or more PLMN IDs, each of the one or more PLMN IDs being associated with the second PLMN, and the UE may store the security information as associated with the one or more PLMN IDs in at least one memory of the UE.

At 1006, the UE may communicate a sidelink message based on the security information generated by the second PLMN. For example, the UE 804 or the UE 904 may communicate a sidelink message (e.g., 834, 936, or 938) based on the security information generated by the second PLMN. In some aspects, 1006 may be performed by security component 198. In some aspects, the UE is an announcing UE, and the sidelink message is an announcement message including the one or more PLMN IDs. In some aspects, to communicate the sidelink message, the UE may transmit the announcement message including the one or more PLMN IDs associated with the second PLMN, the announcement message being protected based on the security information associated with the second PLMN. In some aspects, the UE is a discoveree UE, and the sidelink message is a discovery solicitation message including the one or more PLMN IDs, and to communicate the sidelink message, the UE may receive and decrypt the discovery solicitation message including the one or more PLMN IDs based on the security information associated with the second PLMN and transmit a discovery response message in response to the discovery solicitation message, the discovery response message being protected based on the security information associated with the second PLMN. In some aspects, the UE is a relay UE, where the discovery request is a relay discovery key request message, and where a discovery response associated with the discovery request is a UE-to-Network Relay discovery key response message. In some aspects, the security information is associated with a RSC and includes at least one of: a discovery user integrity key, a discovery user scrambling key, a discovery user confidentiality key, or a ciphering algorithm. In some aspects, the security information is associated with an expiration timer.

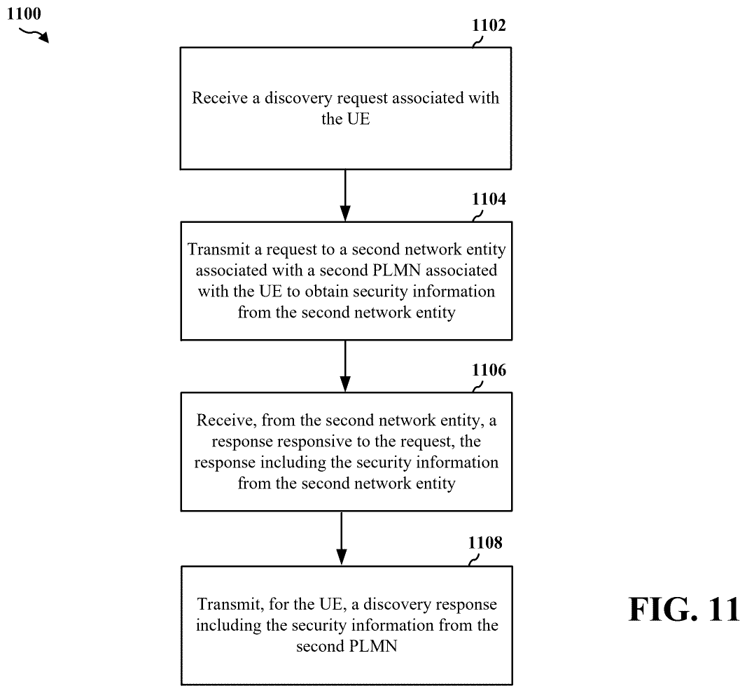

FIG. 11 is a flowchart 1100 of a method of wireless communication. The method may be performed by a network entity (e.g., the base station 102, the DDNMF 810, 910, 806, 906, the network entity 1202, the network entity 1302).

At 1102, the network entity may receive a discovery request associated with the UE. For example, the network entity (e.g., 810 or 910) may receive a discovery request (e.g., 814 or 914) associated with the UE. In some aspects, 1102 may be performed by security component 199.

At 1104, the network entity may transmit a request to a second network entity associated with a second PLMN associated with the UE to obtain security information from the second network entity. For example, the network entity (e.g., 810 or 910) may transmit a request (e.g., as part of 818 or 918) to a second network entity associated with a second PLMN associated with the UE to obtain security information from the second network entity. In some aspects, 1104 may be performed by security component 199.

At 1106, the network entity may receive, from the second network entity, a response responsive to the request, the response including the security information from the second network entity. For example, the network entity (e.g., 810 or 910) may receive, from the second network entity, a response (e.g., as part of 818 or 918) responsive to the request, the response including the security information from the second network entity. In some aspects, 1106 may be performed by security component 199.

At 1108, the network entity may transmit, for the UE, a discovery response including the security information from the second PLMN. For example, the network entity (e.g., 810 or 910) may transmit, for the UE, a discovery response (e.g., 820 or 910) including the security information from the second PLMN. In some aspects, 1106 may be performed by security component 199.

In some aspects, the discovery response further includes one or more PLMN IDs, each of the one or more PLMN IDs being associated with the second PLMN. In some aspects, the first PLMN is a home PLMN (HPLMN) associated with the UE, where the first network entity is a direct discovery name management function (DDNMF) or a proximity services (ProSe) key management function (PKMF) associated with the HPLMN, and where the second PLMN is a visited PLMN (VPLMN) associated with the UE. In some aspects, the security information is associated with a relay service code (RSC) and includes at least one of: a discovery user integrity key, a discovery user scrambling key, a discovery user confidentiality key, or a ciphering algorithm. In some aspects, the security information is associated with an expiration timer. In some aspects, the request is an announce authorization message and the response is an announce authorization acknowledgment message. In some aspects, the UE is a relay UE.

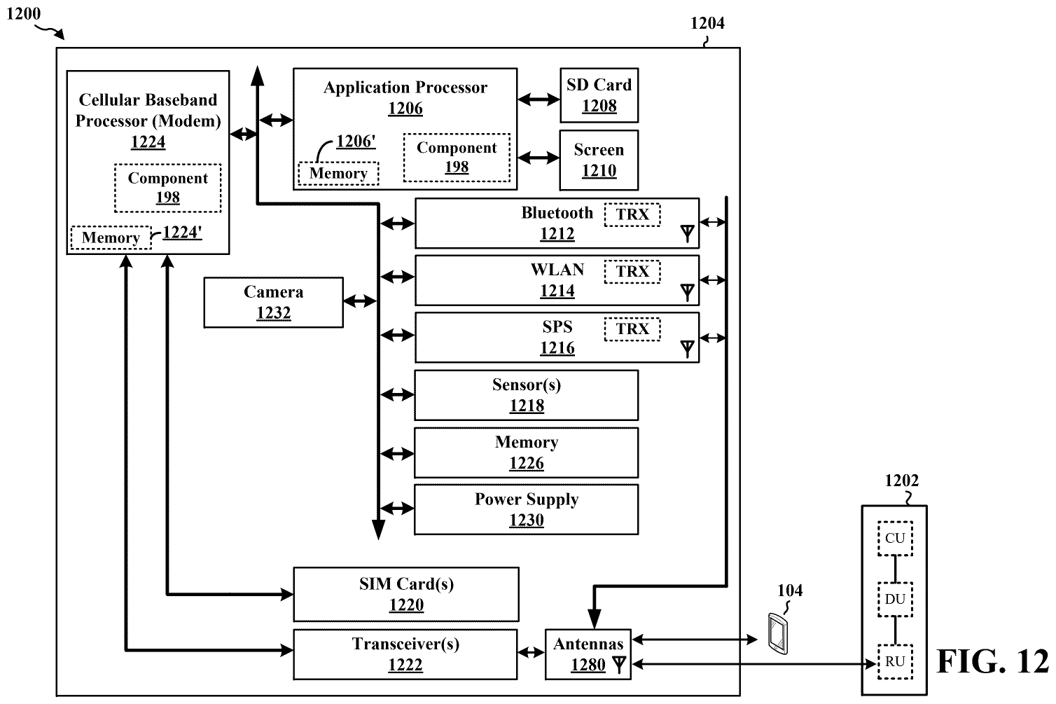

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the security component 198 may be configured to transmit, to a first network entity from a first public land mobile network (PLMN) associated with the UE, a discovery request. In some aspects, the security component 198 may be further configured to receive, from the first network entity from the first PLMN, a discovery response including security information generated by a second network entity from a second PLMN associated with the UE. In some aspects, the security component 198 may be further configured to communicate a sidelink message based on the security information generated by the second PLMN. The security component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for, in accordance with various aspects of the present disclosure. In some aspects, the apparatus 1204 may include means for transmitting a request to a second network entity associated with a second PLMN associated with the UE to obtain security information from the second network entity. In some aspects, the apparatus 1204 may include means for receiving, from the second network entity, a response responsive to the request, the response including the security information from the second network entity. In some aspects, the apparatus 1204 may include means for transmitting, for the UE, a discovery response including the security information from the second PLMN. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

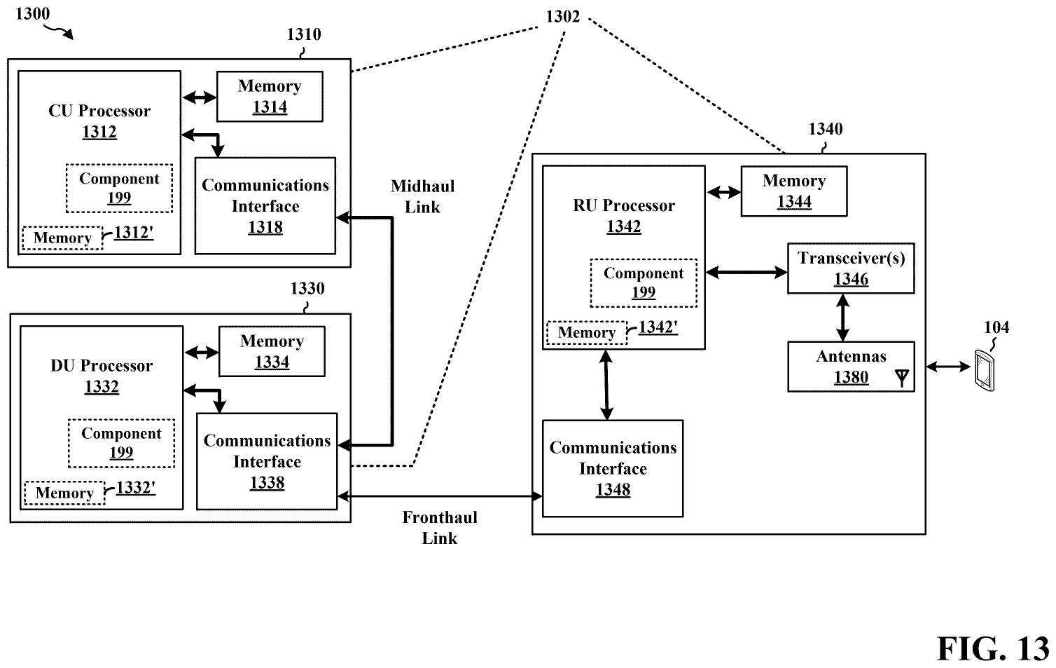

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the security component 199 may be configured to receive a discovery request associated with the UE. In some aspects, the security component 199 may be further configured to transmit a request to a second network entity associated with a second PLMN associated with the UE to obtain security information from the second network entity. In some aspects, the security component 199 may be further configured to receive, from the second network entity, a response responsive to the request, the response including the security information from the second network entity. In some aspects, the security component 199 may be further configured to transmit, for the UE, a discovery response including the security information from the second PLMN. The security component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for receiving a discovery request associated with the UE. In some aspects, the network entity 1302 may include means for transmitting a request to a second network entity associated with a second PLMN associated with the UE to obtain security information from the second network entity. In some aspects, the network entity 1302 may include means for receiving, from the second network entity, a response responsive to the request, the response including the security information from the second network entity. In some aspects, the network entity 1302 may include means for transmitting, for the UE, a discovery response including the security information from the second PLMN. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. One or more processors may be referred to as processor circuitry. Memory/one or more memory modules may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication performed by a user equipment (UE), including: transmitting, to a first network entity from a first public land mobile network (PLMN) associated with the UE, a discovery request; receiving, from the first network entity from the first PLMN, a discovery response including security information generated by a second network entity from a second PLMN associated with the UE; and communicating a sidelink message based on the security information generated by the second PLMN.

Aspect 2 is the method of aspect 1, where the discovery response further includes one or more PLMN IDs, each of the one or more PLMN IDs being associated with the second PLMN, and further including: storing the security information as associated with the one or more PLMN IDs in at least one memory.

Aspect 3 is the method of aspect 2, where the UE is an announcing UE, and where the sidelink message is an announcement message including the one or more PLMN IDs, and where communicating the sidelink message further includes: transmitting the announcement message including the one or more PLMN IDs associated with the second PLMN, the announcement message being protected based on the security information associated with the second PLMN.

Aspect 4 is the method of aspect 2, where the UE is a discoveree UE, and where the sidelink message is a discovery solicitation message including the one or more PLMN IDs, and where communicating the sidelink message further includes: receiving and decrypting the discovery solicitation message including the one or more PLMN IDs based on the security information associated with the second PLMN; and transmitting a discovery response message in response to the discovery solicitation message, the discovery response message being protected based on the security information associated with the second PLMN.

Aspect 5 is the method of any of aspects 1-2, where the UE is a relay UE, where the discovery request is a relay discovery key request message, and where the discovery response associated with the discovery request is a UE-to-Network Relay discovery key response message.

Aspect 6 is the method of any of aspects 1-5, where the first PLMN is a home PLMN (HPLMN) associated with the UE, where the first network entity is a direct discovery name management function (DDNMF) or a proximity services (ProSe) key management function (PKMF) associated with the HPLMN, and where the second PLMN is a visited PLMN (VPLMN) associated with the UE.

Aspect 7 is the method of any of aspects 1-6, where the security information is associated with a relay service code (RSC) and includes at least one of: a discovery user integrity key, a discovery user scrambling key, a discovery user confidentiality key, or a ciphering algorithm.

Aspect 8 is the method of any of aspects 1-7, where the security information is associated with an expiration timer.

Aspect 9 is a method for wireless communication performed by a first network entity associated with a first public land mobile network (PLMN) associated with a user equipment (UE), including: receiving a discovery request associated with the UE; transmitting a request to a second network entity associated with a second PLMN associated with the UE to obtain security information from the second network entity; receiving, from the second network entity, a response responsive to the request, the response including the security information from the second network entity; and transmitting, for the UE, a discovery response including the security information from the second PLMN.

Aspect 10 is the method of aspect 9, where the discovery response further includes one or more PLMN IDs, each of the one or more PLMN IDs being associated with the second PLMN.

Aspect 11 is the method of any of aspects 9-10, where the first PLMN is a home PLMN (HPLMN) associated with the UE, where the first network entity is a direct discovery name management function (DDNMF) or a proximity services (ProSe) key management function (PKMF) associated with the HPLMN, and where the second PLMN is a visited PLMN (VPLMN) associated with the UE.

Aspect 12 is the method of any of aspects 9-11, where the security information is associated with a relay service code (RSC) and includes at least one of: a discovery user integrity key, a discovery user scrambling key, a discovery user confidentiality key, or a ciphering algorithm.

Aspect 13 is the method of any of aspects 9-12, where the security information is associated with an expiration timer.

Aspect 14 is the method of any of aspects 9-13, where the request is an announce authorization message and the response is an announce authorization acknowledgment message.

Aspect 15 is the method of any of aspects 9-14, where the UE is a relay UE.

Aspect 16 is an apparatus for wireless communication at a device including at least one memory and at least one processor coupled to the at least one memory and, the at least one processor, individually or in any combination, based at least in part on information stored in the at least one memory, the at least one processor is configured to implement any of aspects 1 to 8.

Aspect 17 is the apparatus of aspect 16, further including one or more transceivers or one or more antennas coupled to the at least one processor.

Aspect 18 is an apparatus for wireless communication at a device including means for implementing any of aspects 1 to 8.

Aspect 19 is a computer-readable medium (e.g., a non-transitory computer-readable medium) storing computer executable code, where the code when executed by at least one processor causes the at least one processor to implement any of aspects 1 to 8.

Aspect 20 is an apparatus for wireless communication at a device including at least one memory and at least one processor coupled to the at least one memory and, the at least one processor, individually or in any combination, based at least in part on information stored in the at least one memory, the at least one processor is configured to implement any of aspects 9 to 15.

Aspect 21 is the apparatus of aspect 20, further including one or more transceivers or one or more antennas coupled to the at least one processor.

Aspect 22 is an apparatus for wireless communication at a device including means for implementing any of aspects 9 to 15.

Aspect 23 is a computer-readable medium (e.g., a non-transitory computer-readable medium) storing computer executable code, where the code when executed by at least one processor causes the at least one processor to implement any of aspects 9 to 15.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to cause the UE to:
transmit, to a first network entity from a first public land mobile network (PLMN) associated with the UE, a discovery request;
receive, from the first network entity from the first PLMN, a discovery response comprising security information generated by a second network entity from a second PLMN associated with the UE; and
communicate a sidelink message based on the security information generated by the second PLMN.

2. The apparatus of claim 1, wherein the discovery response further comprises one or more PLMN IDs, each of the one or more PLMN IDs being associated with the second PLMN, and wherein the at least one processor is further configured to cause the UE to:
store the security information as associated with the one or more PLMN IDs in the at least one memory.

3. The apparatus of claim 2, wherein the UE is an announcing UE, and wherein the sidelink message is an announcement message including the one or more PLMN IDs, and wherein to communicate the sidelink message, the at least one processor is configured to cause the UE to:
transmit the announcement message including the one or more PLMN IDs associated with the second PLMN, the announcement message being protected based on the security information associated with the second PLMN.

4. The apparatus of claim 2, wherein the UE is a discoveree UE, and wherein the sidelink message is a discovery solicitation message including the one or more PLMN IDs, and wherein to communicate the sidelink message, the at least one processor is configured to cause the UE to:
receive and decrypt the discovery solicitation message including the one or more PLMN IDs based on the security information associated with the second PLMN; and
transmit a discovery response message in response to the discovery solicitation message, the discovery response message being protected based on the security information associated with the second PLMN.

5. The apparatus of claim 1, wherein the UE is a relay UE, wherein the discovery request is a relay discovery key request message, and wherein the discovery response associated with the discovery request is a relay discovery key response message.

6. The apparatus of claim 1, wherein the first PLMN is a home PLMN (HPLMN) associated with the UE, wherein the first network entity is a direct discovery name management function (DDNMF) or a proximity services (ProSe) key management function (PKMF) associated with the HPLMN, and wherein the second PLMN is a visited PLMN (VPLMN) associated with the UE.

7. The apparatus of claim 1, wherein the security information is associated with a relay service code (RSC) and comprises at least one of: a discovery user integrity key, a discovery user scrambling key, a discovery user confidentiality key, or a ciphering algorithm.

8. The apparatus of claim 1, wherein the security information is associated with an expiration timer.

9. An apparatus for wireless communication at a first network entity associated with a first public land mobile network (PLMN) associated with a user equipment (UE), comprising:
at least one memory; and
at least one processor coupled to the at least one memory and, based at least in part on stored information that is stored in the at least one memory, the at least one processor, individually or in any combination, is configured to cause the first network entity to:
receive a discovery request associated with the UE;
transmit a request to a second network entity associated with a second PLMN associated with the UE to obtain security information from the second network entity;
receive, from the second network entity, a response responsive to the request, the response comprising the security information from the second network entity; and
transmit, for the UE, a discovery response comprising the security information from the second PLMN.

10. The apparatus of claim 9, wherein the discovery response further comprises one or more PLMN IDs, each of the one or more PLMN IDs being associated with the second PLMN.

11. The apparatus of claim 9, wherein the first PLMN is a home PLMN (HPLMN) associated with the UE, wherein the first network entity is a direct discovery name management function (DDNMF) or a proximity services (ProSe) key management function (PKMF) associated with the HPLMN, and wherein the second PLMN is a visited PLMN (VPLMN) associated with the UE.

12. The apparatus of claim 9, wherein the security information is associated with a relay service code (RSC) and comprises at least one of: a discovery user integrity key, a discovery user scrambling key, a discovery user confidentiality key, or a ciphering algorithm.

13. The apparatus of claim 9, wherein the security information is associated with an expiration timer.

14. The apparatus of claim 9, wherein the request is an announce authorization message and the response is an announce authorization acknowledgment message.

15. The apparatus of claim 9, wherein the UE is a relay UE.

16. A method for wireless communication performed by a user equipment (UE), comprising:
transmitting, to a first network entity from a first public land mobile network (PLMN) associated with the UE, a discovery request;
receiving, from the first network entity from the first PLMN, a discovery response comprising security information generated by a second network entity from a second PLMN associated with the UE; and
communicating a sidelink message based on the security information generated by the second PLMN.

17. The method of claim 16, wherein the discovery response further comprises one or more PLMN IDs, each of the one or more PLMN IDs being associated with the second PLMN, and further comprising:
storing the security information as associated with the one or more PLMN IDs in at least one memory.

18. The method of claim 17, wherein the UE is an announcing UE, and wherein the sidelink message is an announcement message including the one or more PLMN IDs, and wherein communicating the sidelink message further comprises:
transmitting the announcement message including the one or more PLMN IDs associated with the second PLMN, the announcement message being protected based on the security information associated with the second PLMN.

19. The method of claim 17, wherein the UE is a discoveree UE, and wherein the sidelink message is a discovery solicitation message including the one or more PLMN IDs, and wherein communicating the sidelink message further comprises:
receiving and decrypting the discovery solicitation message including the one or more PLMN IDs based on the security information associated with the second PLMN; and
transmitting a discovery response message in response to the discovery solicitation message, the discovery response message being protected based on the security information associated with the second PLMN.

20. The method of claim 16, wherein the UE is a relay UE, wherein the discovery request is a relay discovery key request message, and wherein the discovery response associated with the discovery request is a UE-to-Network Relay discovery key response message.

21. The method of claim 16, wherein the first PLMN is a home PLMN (HPLMN) associated with the UE, wherein the first network entity is a direct discovery name management function (DDNMF) or a proximity services (ProSe) key management function (PKMF) associated with the HPLMN, and wherein the second PLMN is a visited PLMN (VPLMN) associated with the UE.

22. The method of claim 16, wherein the security information is associated with a relay service code (RSC) and comprises at least one of: a discovery user integrity key, a discovery user scrambling key, a discovery user confidentiality key, or a ciphering algorithm.

23. The method of claim 16, wherein the security information is associated with an expiration timer.

24. A method for wireless communication performed by a first network entity associated with a first public land mobile network (PLMN) associated with a user equipment (UE), comprising:
receiving a discovery request associated with the UE;
transmitting a request to a second network entity associated with a second PLMN associated with the UE to obtain security information from the second network entity;
receiving, from the second network entity, a response responsive to the request, the response comprising the security information from the second network entity; and
transmitting, for the UE, a discovery response comprising the security information from the second PLMN.

25. The method of claim 24, wherein the discovery response further comprises one or more PLMN IDs, each of the one or more PLMN IDs being associated with the second PLMN.

26. The method of claim 24, wherein the first PLMN is a home PLMN (HPLMN) associated with the UE, wherein the first network entity is a direct discovery name management function (DDNMF) or a proximity services (ProSe) key management function (PKMF) associated with the HPLMN, and wherein the second PLMN is a visited PLMN (VPLMN) associated with the UE.

27. The method of claim 24, wherein the security information is associated with a relay service code (RSC) and comprises at least one of: a discovery user integrity key, a discovery user scrambling key, a discovery user confidentiality key, or a ciphering algorithm.

28. The method of claim 24, wherein the security information is associated with an expiration timer.

29. The method of claim 24, wherein the request is an announce authorization message and the response is an announce authorization acknowledgment message.

30. The method of claim 24, wherein the UE is a relay UE.
